(19) United States
(12) Patent Application Publication
(10) Pub. No.: US 2007/0081371 A1
(43) Pub. Date: Apr. 12, 2007

(54) Synchronous Rectifier Control Circuits

(76) Inventor: Ernest Henry Wittenbreder JR., Flagstaff, AZ (US)

Correspondence Address: ERNEST H. WITTENBREDER, 3260 SOUTH GILLENWATER DRIVE, FLAGSTAFF, AZ, 86001, US

(21) Appl. No.: 11/379,820

(22) Filed: Apr. 24, 2006

Related U.S. Application Data
(60) Provisional application No. 60/674,563, filed on Apr. 25, 2005.

(51) Int. Cl. H02M 7/217

(52) U.S. Cl. 363/127

(57) ABSTRACT

The subject invention reveals a method to sample the drain source voltage of a power mosfet synchronous rectifier during its on time using high speed low voltage analog comparators and operational amplifiers. The method relies on a sampling switch such as a small signal level high voltage enhancement mode mosfet that is enabled when the drain source voltage of the power mosfet is near zero volts. The sampling switch isolates and protects the high speed low voltage analog circuit from the high voltages present on the drain of the power mosfet during the off state of the power mosfet.

### CROSS-REFERENCE TO RELATED APPLICATIONS

This application claims the benefit of PPA Ser. Nr. 60/674,563, filed 2005 Apr. 25 by the present inventor.

### BACKGROUND OF THE INVENTION

1. Field of the Invention

The subject invention generally pertains to electronic power conversion circuits, and more specifically to synchronous rectifiers in high frequency, switched mode electronic power converters.

2. Description of Related Art

In modern commercial power electronic circuits passive rectifiers are generally composed of silicon. For low voltage applications schottky barrier rectifier types dominate and in higher voltage applications ultra-fast junction rectifiers dominate. As demands for higher efficiency power conversion increase more designs are employing synchronous rectifiers which are power mosfets that, ideally, turn on when the direction of current is from source to drain and turn off when the direction of current is from drain to source in a typical N channel device. The efficiency is improved with synchronous rectification when the channel voltage of the synchronous rectifier is lower than the forward voltage of the diode rectifier that it replaces. For the synchronous rectifier the channel voltage is the product of the channel current and the on resistance of the power mosfet. For a diode rectifier there is a component of forward voltage that is independent of current, which accounts for most of its forward voltage. In many cases there are timing signals available in the power converter that can be used to turn the synchronous rectifier on and off at the right times, but in some cases, such as discontinuous current mode (DCM), also known as complete energy transfer, there is no pre-existing control signal or naturally occurring signal to turn off the synchronous rectifier. Even when timing signals are available to trigger the turn on and turn off transitions often the timing signals are not optimal and result in significant power losses or reliability issues related to the turn on of the body diode, which often has a large reverse recovery time. During reverse recovery a diode rectifier remains conducting for a short period after the applied voltage has become reverse biased, due to charge storage effects in the semiconductor PN junction. There are several circuits in the existing art that have sought to provide turn on and turn off signals for synchronous rectifiers. An example of one of these circuits is illustrated in FIG. 1(a). The FIG. 1(a) circuit uses an inverting gate driver with its input connected to the drain terminal of the synchronous rectifier to control the gate of the synchronous rectifier. This circuit requires a gate driver circuit that can tolerate the maximum drain voltage of the synchronous rectifier. Also, the threshold for switching must be close to the source voltage of the synchronous rectifier or the ground reference terminal of the gate driver so that the channel current does not reverse in the synchronous rectifier. For integrated circuit (IC) gate drivers the first requirement of surviving the drain voltage at the input can be met, but only for power converters that operate from a low voltage line, and the second requirement of a threshold voltage at or near enough to ground is not available to the applicant's knowledge at the time of this writing.

An improved circuit, illustrated in FIG. 1(b), uses a comparator to sense the voltage across the synchronous rectifier and provide timing for a gate drive circuit to turn the mosfet on and off. In the FIG. 1(b) circuit the comparator output goes positive when the drain voltage of the synchronous rectifier falls below its source voltage. When the current in the synchronous rectifier drops towards zero the drain voltage rises with respect to the source voltage and when the drain voltage becomes positive with respect to the source the comparator changes state turning off the power mosfet. This would seem to be a simple and adequate solution to controlling the synchronous rectifier, but there are some practical problems in the implementation that require further examination in many cases. The comparator must be capable of withstanding the maximum drain voltage of the synchronous rectifier at its input and it must be capable of handling voltages below its ground reference voltage, unless a separate low voltage rail is provided for the comparator with a voltage that is negative with respect to the voltage level of the source terminal of the synchronous rectifier. Most commercially available IC comparators that are fast enough to be useful for synchronous rectifier applications in modern high frequency power converters are not available with input differential voltages that can exceed much more than five volts. The input voltage problem can be overcome by using a diode resistor clamp, as illustrated in FIG. 1(c), but this solution either reduces the speed of the comparator since the comparator's transition time is dependent on the circuit parasitic capacitances, such as the intrinsic capacitance of the diode and the input capacitance of the comparator, for a large resistor value, or significant power losses are incurred during the off state of the synchronous rectifier for a low value resistor. Also large value resistors at the input create input errors due to input offset and input bias currents. The inputs can be diode coupled so that diodes are reverse biased when the synchronous rectifier's drain voltage is high and forward biased when the synchronous rectifier's drain voltage is near to its source voltage, but the input diodes will compromise the offset voltage performance of the comparator.

What is needed is a synchronous rectifier control solution that can tolerate high synchronous rectifier drain voltages without sacrificing speed or offset voltage performance while sensing the turn off threshold very near to the potential of the synchronous rectifier's source terminal.

### OBJECTS AND ADVANTAGES

An object of the subject invention is to reveal a synchronous rectifier control circuit that is not sensitive to synchronous rectifier drain voltage and which provides both optimal turn on timing and optimal turn off timing for the synchronous rectifier.

Further objects and advantages of my invention will become apparent from a consideration of the drawings and ensuing description.

These and other objects of the invention are provided by novel circuit techniques that employs a sampling switch that operates substantially in synchronization with the power mosfet, thereby protecting the voltage sensing circuits from the drain voltage of the power mosfet. The operation of the circuit relies on known circuits that can provide optimal zero voltage turn on timing considering the charge transfers that occur during the turn on transition. New circuits are revealed that optimize the turn off timing of the synchronous rectifier.

### BRIEF DESCRIPTION OF THE DRAWINGS

The present invention is illustrated by reference to the drawings.

FIG. 1(a) illustrates a synchronous rectifier control scheme according to the prior art.

FIG. 1(b) illustrates an improved synchronous rectifier control scheme according to the prior art.

FIG. 1(c) illustrates a method of improving the FIG. 1(b) circuit for circuits with higher synchronous rectifier drain voltages.

FIG. 2 illustrates a synchronous rectifier control circuit according to the subject invention.

FIG. 3 illustrates a sampling gate that disables the comparator used for sensing the turn off threshold during the turn on transition according to the subject invention.

FIG. 4 illustrates a flip flop circuit used for setting the on/off state of the synchronous rectifier according to the subject invention.

FIG. 5 illustrates a gate driver circuit that optimally turns on the synchronous rectifier at zero voltage according to the subject invention.

FIG. 6 illustrates an amplifier circuit that inverts and amplifies the sensed synchronous rectifier channel voltage to accommodate ICs that cannot operate below ground reference voltage and to provide a larger input differential over voltage for faster comparator switching according to the subject invention.

FIG. 7 illustrates the FIG. 6 circuit with comparator hysteresis and a non-zero threshold voltage according to the subject invention.

FIG. 8(a) illustrates the drain source voltage of a power mosfet synchronous rectifier according to the subject invention.

FIG. 8(b) illustrates the drain to source current of a power mosfet synchronous rectifier according to the subject invention.

FIG. 8(c) illustrates the voltage wave form at the node A of the FIG. 7 circuit according to the subject invention.

FIG. 8(d) illustrates the voltage wave form at the node B of the FIG. 7 circuit according to the subject invention.

FIG. 8(e) illustrates the voltage wave form at the node C of the FIG. 7 circuit according to the subject invention.

FIG. 8(f) illustrates the voltage wave form at the node D of the FIG. 7 circuit according to the subject invention.

FIG. 8(g) illustrates the voltage wave form at the node E of the FIG. 7 circuit according to the subject invention.

FIG. 8(h) illustrates the voltage wave form of the node F of the FIG. 5 circuit according to the subject invention.

FIG. 8(i) illustrates the voltage wave form of the node G of the FIG. 5 circuit according to the subject invention.

FIG. 8(j) illustrates the voltage wave form of the node H of the FIG. 7 circuit according to the subject invention.

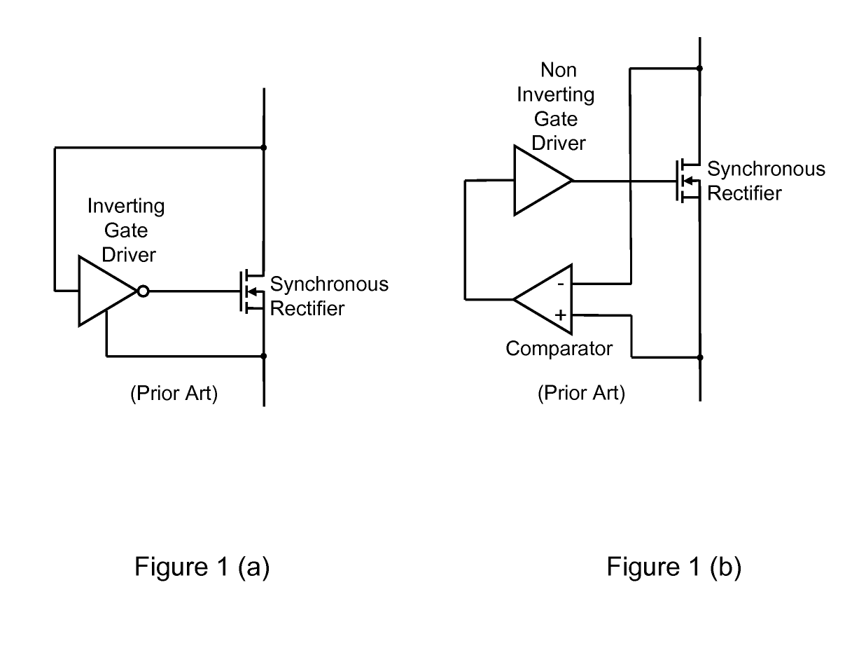

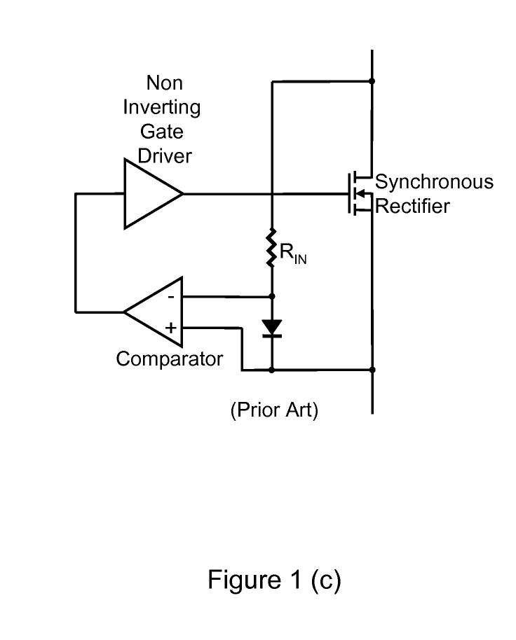

### SUMMARY

The subject invention uses a circuit that employs a small sampling switch to sense the channel voltage of a synchronous rectifier, thereby reducing the maximum voltage to the sensing circuits to less than one volt. The channel voltage sensing circuits are inactive when the synchronous rectifier is in an off state. A gate timing circuit is used for providing optimal timing for a turn on transition of the synchronous rectifier. Other circuits that render the circuit more practical with readily available ICs are revealed.

### DESCRIPTION OF THE PREFERRED EMBODIMENTS

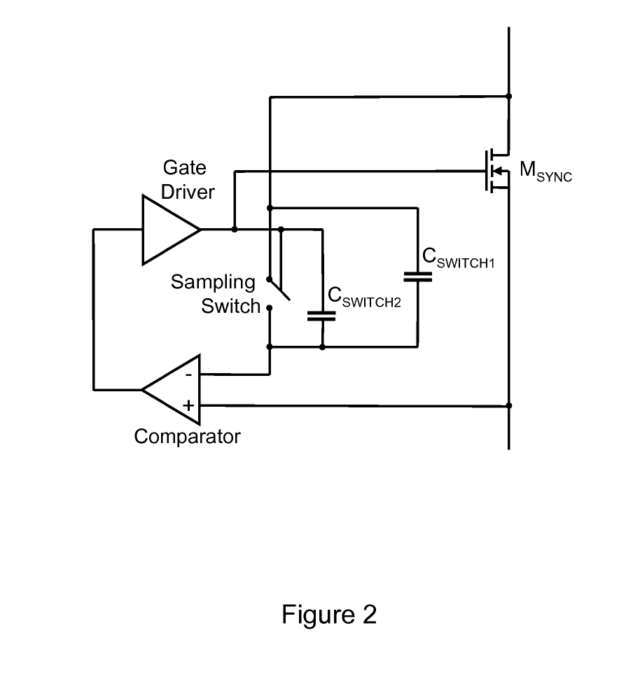

FIG. 2 illustrates a synchronous rectifier circuit which includes a sampling switch. The sampling switch overcomes the problems referred to above in that the sampling switch disconnects the comparator from the drain of the synchronous rectifier when the synchronous rectifier is disabled. The drain voltage can be high and the sampling switch blocks the high drain voltage from the low voltage sensing circuit. The sampling switch provides a low impedance to the voltage that needs to be sensed during the on time of the synchronous rectifier.

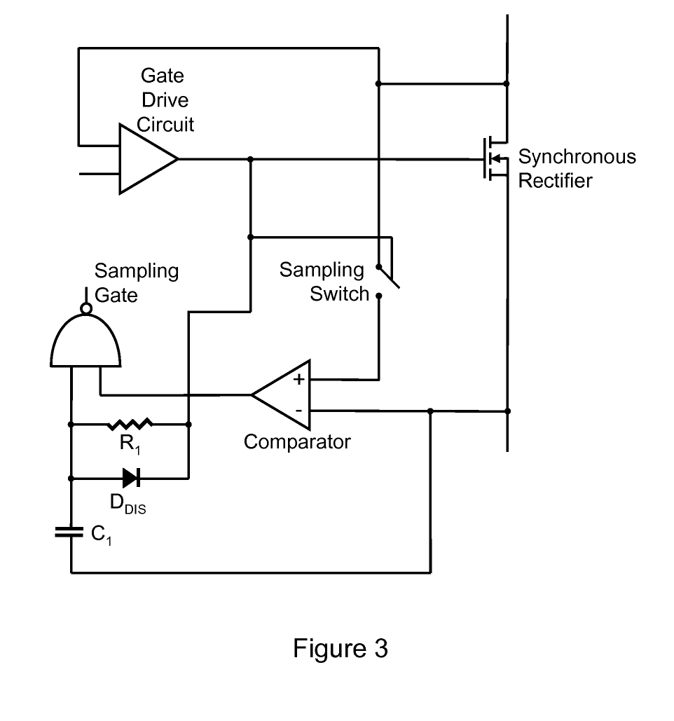

The synchronous rectifier is ideally turned on at the instant that the drain to source voltage falls to zero volts. As the drain voltage falls any parasitic capacitance associated with the main terminals of the sampling switch will cause the inverting input of the comparator to fall thereby raising the voltage at the comparator output and causing the gate of the power mosfet to be enhanced prior to the time that the drain source voltage has reached zero volts. Also, if there is parasitic capacitance between the control terminal of the sampling switch and the input to the comparator the turn on transition at the gate of the synchronous rectifier can be coupled to the input of the comparator, raising the voltage at the inverting input of the comparator causing the output of the comparator to fall and initiate a turn off transition. Both of these effects are undesirable and can be eliminated by the use of a sampling gate, as illustrated in FIG. 3.

In the FIG. 3 circuit the sampling gate circuit consists of a two input NAND gate and a diode RC circuit for delaying the rise in voltage at one of the inputs to the NAND gate. Also in the FIG. 3 circuit, the inputs to the comparator are reversed so that the comparator output is normally low during the on state of the synchronous rectifier. The comparator output transitions to a high state when the current in the synchronous rectifier drops to zero. The diode RC circuit consists of R₁, C₁, and D_{DIS}. During the off state of the synchronous rectifier the input to the NAND gate connected to C₁ is low because the gate of the synchronous rectifier is low. When the gate of the synchronous rectifier is enabled the input to the NAND gate at C₁ begins to rise, but is delayed because of R₁ so that the output of the NAND gate remains in a high state for a period of time after the gate of the synchronous rectifier is enabled due to the low voltage at the NAND input connected to C₁. During the time that C₁ is low and rising any effects on the comparator due to the charging or discharging of parasitic capacitances at the inputs to the comparator are ignored at the output of the NAND gate due to the fact the input to the NAND gate connected to C₁ is low, forcing the output to the NAND gate to remain in the high state. Because of the diode D_{DIS} there is no delay at the C₁ input during the high to low transition at the gate of the synchronous rectifier so that any change of state of the comparator is disabled at the NAND gate output during the off time of the synchronous rectifier.

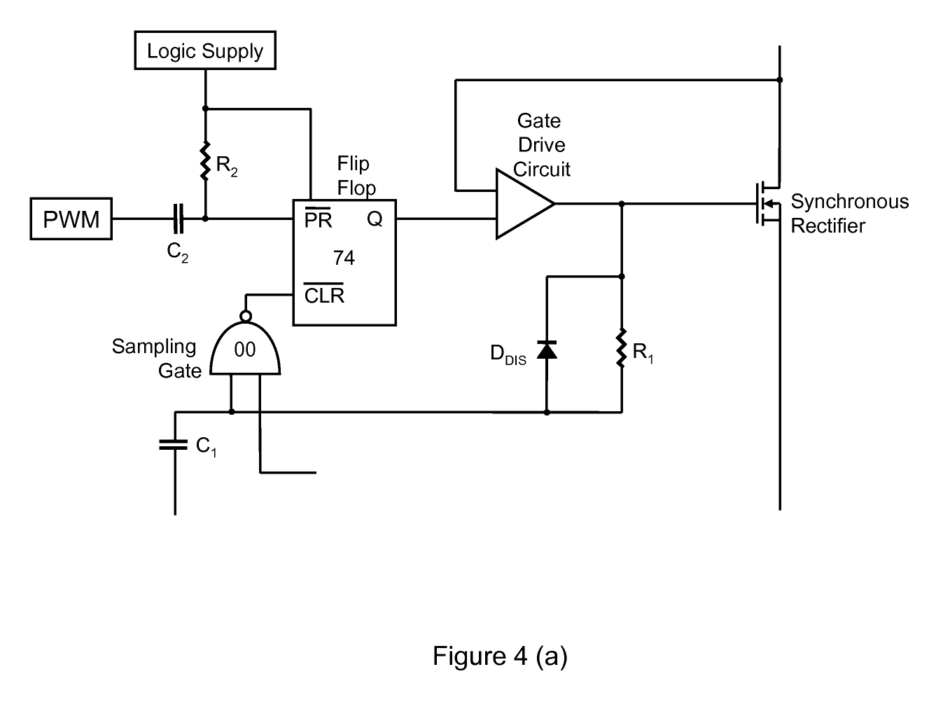

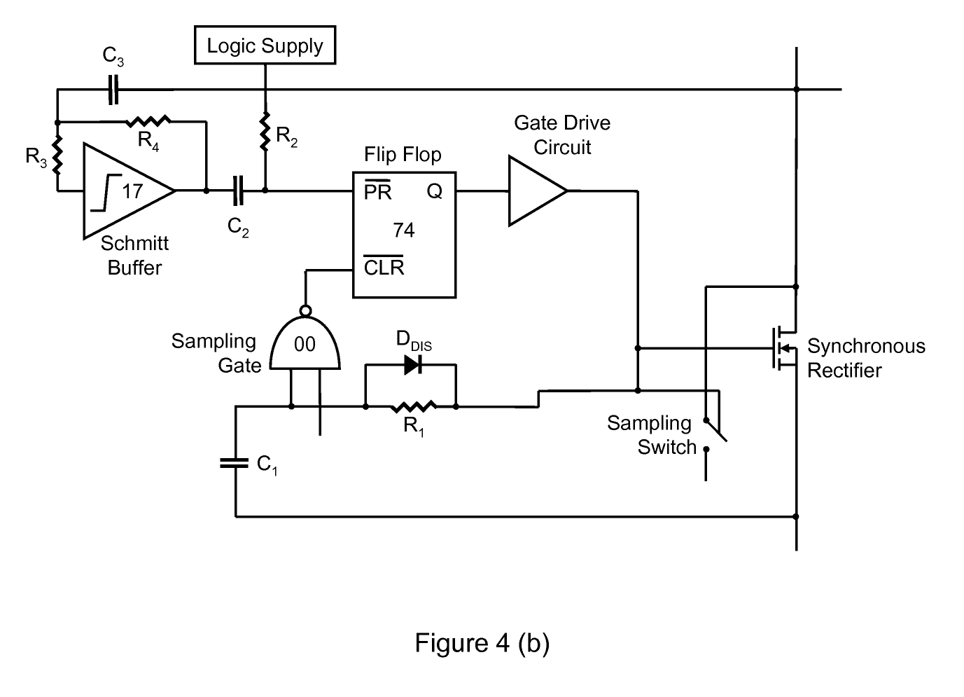

FIG. 4(a) illustrates how the sampling gate is used with a flip flop to set the state of the synchronous rectifier. When the synchronous rectifier current drops to zero in the FIG. 3 circuit the comparator output transitions to the high state and the output of the NAND gate transitions to the low state. At the CLR input to the flip flop a low state forces the Q output to a low state initiating a turn off transition of the synchronous rectifier. The on state is initiated by a low state at the PR input to the flip flop. In many power converter circuits a PWM control signal is available which serves to set the state of the main switch. The synchronous rectifier will, in general, turn on at the end of the on state of the main switch, so that, at the instant that the PWM control signal transitions to the low state, the turn on transition for the synchronous rectifier should be initiated. In FIG. 4(a) a low transition of the PWM control signal briefly forces the PR input to the low state which forces the Q output of the flip flop to the high state. The action of C₂ and R₂ is to follow the falling edge of the PWM control signal at the PR input and then to gradually rise up so that there is a brief low pulse at the PR input to the flip flop. The gate drive circuit illustrated in FIG. 4(a) responds immediately to a low state at the Q output of the flip flop disabling the gate of the synchronous rectifier, but the gate drive circuit does not enable the gate of the synchronous rectifier immediately. Instead the gate drive circuit senses the falling drain to source voltage of the synchronous rectifier and enables the gate of the synchronous rectifier at the instant that its drain to source voltage reaches zero volts.

In the case that there is no PWM control signal readily available to provide turn on timing information, a PWM control signal can be generated from the synchronous rectifier, as illustrated in FIG. 4(b). In the FIG. 4(b) circuit a fast falling edge at the drain of the synchronous rectifier causes the output of a Schmitt buffer to transition to the low state. The output of the Schmitt buffer transitions to a high state during the off transition of the synchronous rectifier as the drain voltage quickly rises. The resistor R₃ limits the current into the Schmitt buffer to a value safely below its maximum input current rating while the resistor R₄ provides a positive current feedback which holds the Schmitt trigger in its existing state until the current in the capacitor C₂ reaches a threshold value characteristic of a turn off transition or turn on transition of the converter's main switch. The capacitor C₂ is typically a very small value so that its impact on circuit operation is negligible.

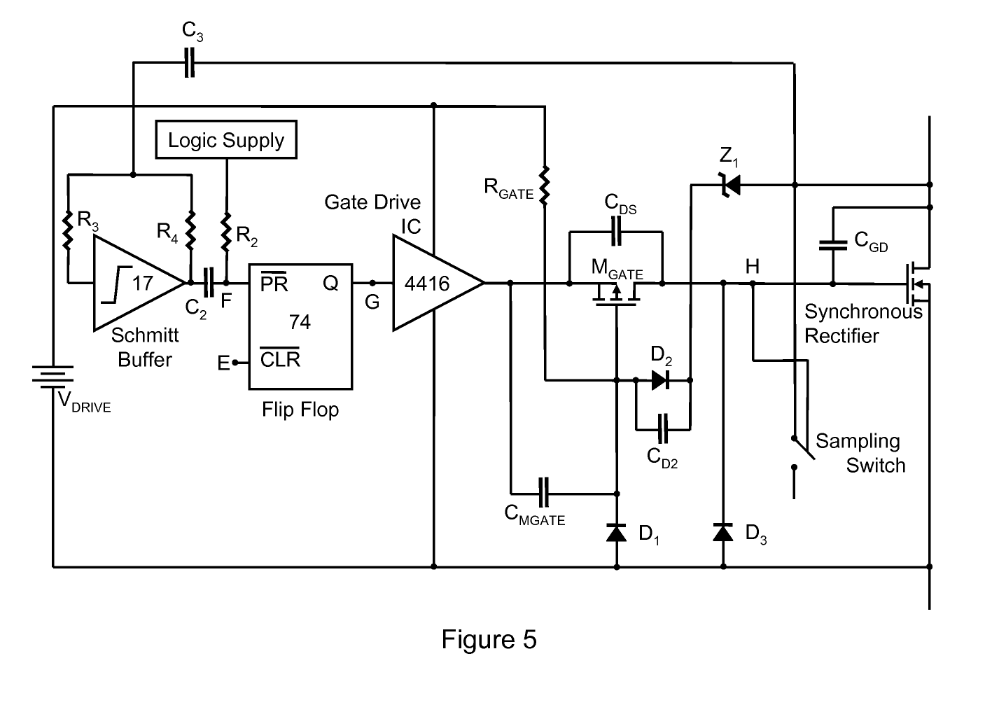

FIG. 5 illustrates the details of a gate drive circuit that provides fast and immediate turn off and optimal turn on timing of the synchronous rectifier. Immediately following a low transition of the Q output of the flip flop the gate drive IC transitions to a low state and forward biases the body diode of the P channel mosfet M_{GATE}, which accomplishes a fast and immediate turn off transition of the synchronous rectifier. When the Q output of the flip flop transitions to the high state the gate drive IC responds immediately but the P channel mosfet remains off until its gate is driven low by the drain of the synchronous rectifier falling to the source voltage of the synchronous rectifier. When the source of M_{GATE} is driven high by the output of the gate drive IC the gate terminal of M_{GATE} is also driven high due to the gate source capacitance of M_{GATE}, so that M_{GATE} remains in an off state. A small amount of the low to high transition voltage and charge can be transferred to the gate of the synchronous rectifier due to the drain source capacitance of M_{GATE}, but the amount of charge that is transferred to the gate of the synchronous rectifier is not sufficient to bring the gate voltage near to its threshold level. Also, the falling drain voltage of the synchronous rectifier tends to force the synchronous rectifier's gate voltage lower due to the current that flows in the gate drain capacitance of the synchronous rectifier, C_{GD}. The diode D₃ clamps the negative movement of the gate of the synchronous rectifier during the turn on transition of the synchronous rectifier and reduces the amount of charge that must be provided to the gate of the synchronous rectifier by the gate drive circuit during the turn on transition. As the drain voltage of the synchronous rectifier approaches the source voltage the diode D₂ becomes forward biased as the zener diode Z₁ begins to avalanche.

The zener diode can be selected so that the gate voltage passes through its threshold just as the drain to source voltage reaches zero volts.

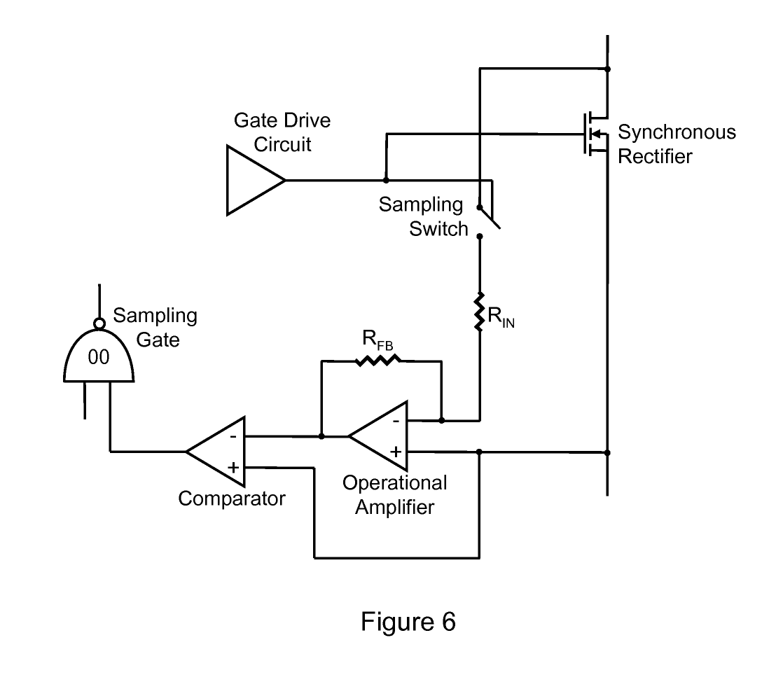

FIG. 6 illustrates a method of enhancing the responsiveness of the comparator circuit by amplifying and inverting the synchronous rectifier's channel voltage. The response time of a comparator is dependent on the magnitude of its input differential voltage so that the comparator will respond faster to a signal which has a larger magnitude than to a signal with a smaller magnitude, everything else being equal. A larger magnitude signal also largely eliminates input offset errors at the comparator input, relying on the input offset performance of the operational amplifier. Inverting the negative channel voltage creates a positive voltage at the comparator input which eases implementing the comparator since a negative supply rail for the comparator is obviated.

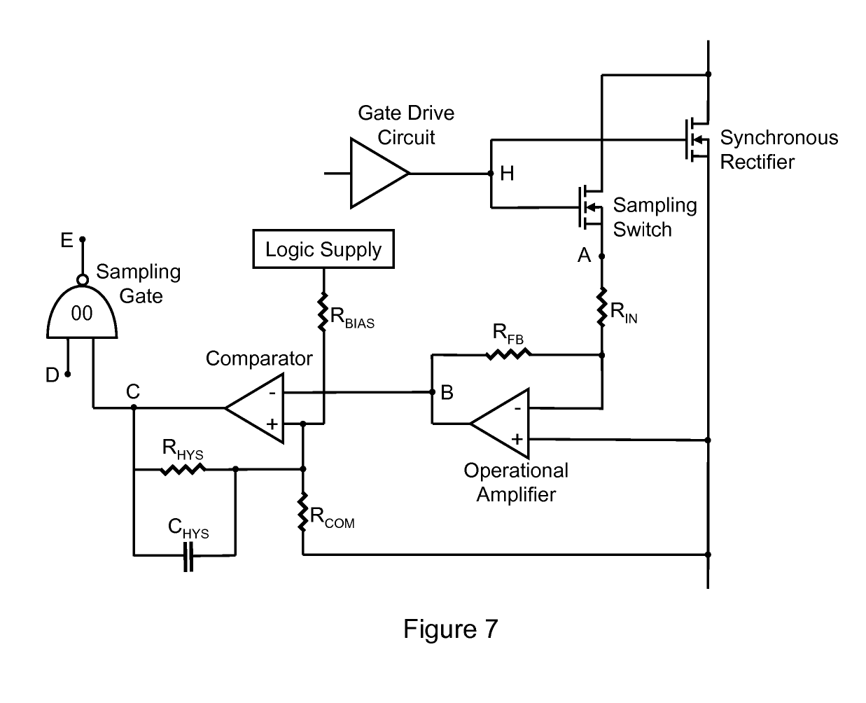

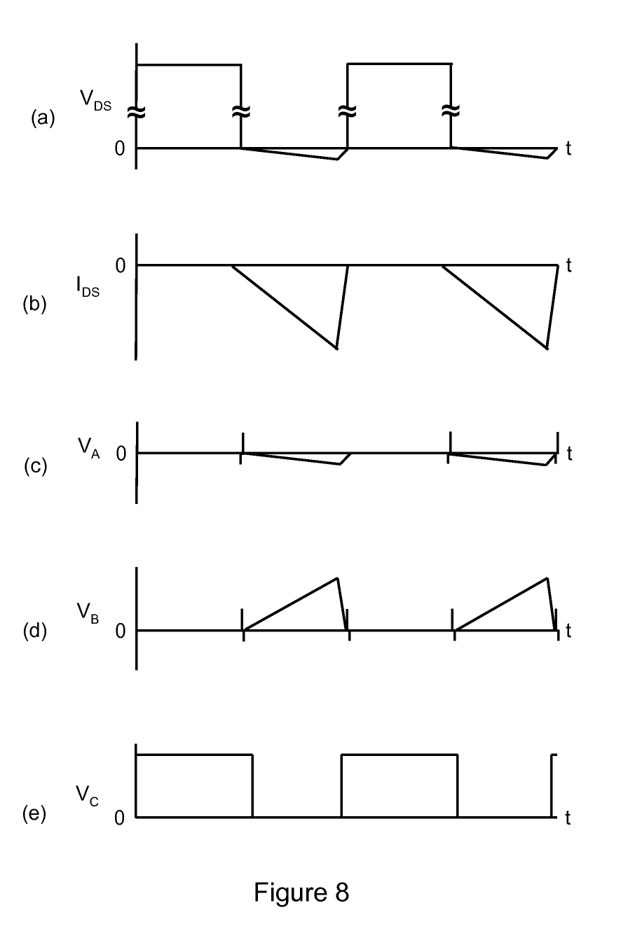

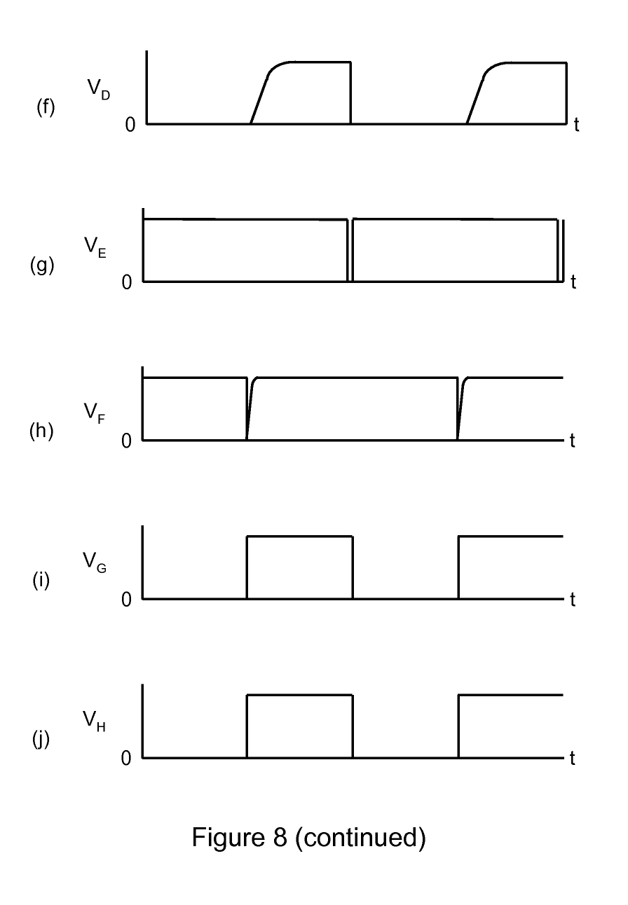

FIG. 7 illustrates the comparator circuit with hysteresis and a small bias voltage added so that the turn off transition of the synchronous rectifier can be initiated at a time prior to the time that the synchronous rectifier current falls to zero. The small bias voltage anticipates the drop in current to zero, compensating for the delay times naturally occurring in the circuit, so that by initiating the transition prior to the channel current reaching zero, the actual transition will occur nearer to the desired zero current. The hysteresis provides for transitions at the comparator output without noise and ringing. FIG. 7 also illustrates how a sampling switch can be implemented using a small mosfet device.

### CONCLUSION, RAMIFICATIONS, AND SCOPE OF INVENTION

Thus the reader will see that by employing a sampling switch some of the problems associated with synchronous rectifier control can be overcome. The reader will also see how using a sampling switch in combination with an inverting amplifier, comparator, sampling gate, flip flop, and gate driver circuit yields a synchronous rectifier with both optimal turn on and turn off timing.

I claim:

1. A synchronous rectifier circuit comprising,
a power mosfet having a drain terminal, a source terminal, and a gate terminal,
a sampling switch having a first main terminal, a second main terminal, and a control terminal with said first main terminal connected to said drain terminal of said power mosfet, operable substantially in synchronization with said power mosfet,
a high speed comparator circuit having a first input terminal, a second input terminal, and an output terminal with said first input terminal coupled to said second main terminal of said sampling switch and with said second input terminal coupled to said source terminal of said power mosfet,
a gate drive circuit having a first input terminal, a second input terminal, and an output terminal with said first input terminal coupled to said output terminal of said high speed comparator circuit and with said output terminal coupled to said gate terminal of said power mosfet,
whereby said sampling switch enables the sensing of a channel voltage of said power mosfet by said high speed comparator during the time that said power mosfet is enabled and said high speed comparator provides a timing pulse to initiate a turn off transition of said power mosfet when said channel voltage of said power mosfet is substantially zero.

2. The synchronous rectifier circuit of claim 1 wherein said sampling switch comprises an enhancement mode mosfet.

3. The synchronous rectifier circuit of claim 1 wherein said gate driver circuit comprises,
a set/reset flip flop,
a gate drive integrated circuit,
a circuit that senses a drain to source voltage of said power mosfet and holds off gate enhancement of said mosfet until said drain to source voltage of said power mosfet is substantially zero.

4. The synchronous rectifier circuit of claim 1 wherein said high speed comparator circuit comprises,
an amplifier circuit,
a high speed integrated circuit comparator,
a sampling gate that prevents initiation of a turn off transition of said power mosfet until after said power mosfet has been fully enhanced.
